(19) United States
(12) Patent Application Publication
(10) Pub. No.: US 2007/0022792 A1
(43) Pub. Date: Feb. 1, 2007

(54) Vehicle Lock

(75) Inventors: Eric Xavier, Middletown, NY (US); Adam Xavier, Middletown, NY (US)

Correspondence Address: BROWN & MICHAELS, PC;400 M & T BANK BUILDING, 118 NORTH TIOGA ST, ITHACA, NY, 14850, US

(73) Assignee: NEW HAMPTON TECHNOLOGIES, LLC, Middletown, NY (US)

(21) Appl. No.: 11/425,564

(22) Filed: Jun. 21, 2006

Related U.S. Application Data
(63) Continuation-in-part of application No. 11/350,573, filed on Feb. 9, 2006.
(60) Provisional application No. 60/703,745, filed on Jul. 29, 2005.

(51) Int. Cl. E05B 67/36; E05B 71/00

(52) U.S. Cl. 70/33; 70/233

(57) ABSTRACT

The vehicle brake-rotor lock includes a mounting bracket, and a lock mechanism, including at least one deadbolt shaft used to mechanically immobilize the vehicle. The bracket is preferably permanently attached to the protected vehicle. In a preferred embodiment, a groove around the brake bolt and a security pin increase the security of the lock by inhibiting drilling attacks. In another preferred embodiment, the deadbolt is spring-loaded. In yet another embodiment, the vehicle lock is designed for one-handed operation for both locking and unlocking the vehicle.

### REFERENCE TO RELATED APPLICATIONS

This application claims an invention which was disclosed in Provisional Application No. 60/703,745, filed Jul. 29, 2005, entitled “RECREATIONAL VEHICLE LOCK”. The benefit under 35 U.S.C. § 119(e) of the U.S. provisional application is hereby claimed, and the aforementioned application is hereby incorporated herein by reference.

This is a continuation-in-part patent application of copending application Ser. No. 11/350,573, filed Feb. 9, 2006, entitled “VEHICLE LOCK”. The aforementioned application is hereby incorporated herein by reference.

### BACKGROUND OF THE INVENTION

1. Field of the Invention

The invention pertains to the field of locks. More particularly, the invention pertains to vehicle locks.

2. Description of Related Art

Two major problems exist with currently available rotor locks for motorcycles and other recreational-type vehicles. First, they do not eliminate fore and aft movement of the wheel or track. Second, when not in use, i.e. when the lock is in an unlocked state, they must be stored somewhere other than on the motorcycle wheel.

When using immobilizers on vehicles, such as motorcycles, mopeds, ATVs, and snowmobiles, there is a need to prevent the possibility of accidental damage to the rotor, caliper, or wheel rim of the vehicle. To satisfy this requirement, it is necessary to eliminate any and all forward or rearward slack between the immobilizing member and the rotor, caliper, or wheel of the vehicle.

One drawback to conventional external locking mechanisms on vehicle braking systems is the slack in the locking point. This slack can cause damage to braking parts when forward and rearward movement takes place. Conventional locking mechanisms offer some wheel immobilization, but allow room for unwanted forward and rearward movement.

Additionally, the application of external locking mechanisms of the prior art creates the possibility of locking mechanism misplacement and locking mechanism storage difficulties on small vehicles. Externally applied locking mechanisms need to be placed into storage when the vehicle is in use, therefore creating a burden on the user to find a storage location. This inconvenience to the user may lead the user to avoid using the vehicle lock on a regular basis. Therefore, there is a need in the art for both a fully immobilizing rotor lock and a permanently mounted rotor lock that remains on the vehicle, does not need to be stored, and is much more convenient for the user.

### SUMMARY OF THE INVENTION

The vehicle brake-rotor lock includes a mounting bracket, and a lock mechanism, including at least one deadbolt shaft used to mechanically immobilize the vehicle. The bracket is preferably permanently attached to the protected vehicle. In a preferred embodiment, a groove around the brake bolt and a security pin increase the security of the lock by inhibiting drilling attacks. In another preferred embodiment, the deadbolt is spring-loaded. In yet another embodiment, the vehicle lock is designed for one-handed operation for both locking and unlocking the vehicle.

In a first embodiment, the vehicle lock is for a vehicle having at least one wheel or track having a brake rotor with a plurality of ventilation holes or slots. The vehicle lock includes a lock body permanently mounted to the vehicle, a lock cylinder mounted in a lock bore of the lock body, a locking pin extending from the lock cylinder, and a brake bolt. The brake bolt is selectively mountable in a brake bolt bore in the lock body. The brake bolt includes a brake bolt body and a deadbolt. The brake bolt body has a deadbolt bore and a diameter groove located around the full circumference of the brake bolt body. The deadbolt extends from the deadbolt bore. In a locked state the locking pin inserts into the diameter groove to hold the brake bolt in the lock body while the diameter groove allows 360° of rotation of the brake bolt body in the brake bolt bore.

In a second embodiment, the vehicle lock includes a lock body permanently mounted to the vehicle, a lock cylinder mounted in a lock bore of the lock body, a locking pin extending from the lock cylinder, and a brake bolt selectively mountable in a brake bolt bore in the lock body. The brake bolt includes a brake bolt body, a deadbolt, and a security pin. The brake bolt body has a deadbolt bore, a security pin bore substantially perpendicular to the deadbolt bore, and a diameter groove located in the exterior of the brake bolt body. In a locked state the locking pin inserts into the diameter groove to hold the brake bolt in the lock body. The deadbolt extends from the deadbolt bore. The security pin is located in the security pin bore. The security pin inhibits penetration of a drilling attack to the brake bolt.

In a third embodiment, the vehicle lock includes a lock body permanently mounted to the vehicle, a lock cylinder mounted in a lock bore of the lock body, a locking pin extending from the lock cylinder, and a brake bolt selectively mountable in a brake bolt bore in the lock body. The brake bolt includes a brake bolt body, a deadbolt, and a pressure spring. The brake bolt body has a deadbolt bore and a diameter groove located in the exterior of the brake bolt body. In a locked state the locking pin inserts into the diameter groove to hold the brake bolt in the lock body. The deadbolt extends from the deadbolt bore. The pressure spring biases the deadbolt outward from the brake bolt body.

In a fourth embodiment, the method includes inserting a brake bolt into a brake bolt bore of a lock body permanently mounted to the vehicle until a locking pin inserts into a diameter groove of the brake bolt to hold the brake bolt in the lock body. The brake bolt includes a brake bolt body having a deadbolt bore, a diameter groove located in the exterior of the brake bolt body, and a deadbolt extending from the deadbolt bore. The lock body includes a lock cylinder mounted in a lock bore of the lock body and the locking pin biased to extend from the lock cylinder into the brake bolt bore.

In a fifth embodiment, the method includes actuating a lock cylinder to retract a locking pin from a diameter groove such that a pressure spring biasing a deadbolt toward the brake rotor pushes a brake bolt body outward from a brake bolt bore in a lock body. When the lock cylinder is no longer actuated a brake bolt may be pulled from the brake bolt bore. The lock body is permanently mounted to the vehicle and includes a lock bore and the brake bolt bore. The brake bolt includes the brake bolt body having a deadbolt bore, the diameter groove located in the exterior of the brake bolt body, the pressure spring, and the deadbolt extending from the deadbolt bore. The lock body includes the lock cylinder mounted in the lock bore and the locking pin biased to extend from the lock cylinder into the brake bolt bore in an unactuated state.

### BRIEF DESCRIPTION OF THE DRAWINGS

FIG. 1 shows a lock assembly on a rear brake caliper mounting bracket of a motorcycle in an embodiment of the present invention.

FIG. 2 shows a lock assembly on a front brake caliper housing in an embodiment of the present invention.

FIG. 3 shows a lock assembly in an embodiment of the present invention.

FIG. 4 shows a first lock mechanism of the present invention in an unlocked state with the brake bolt removed.

FIG. 5 shows the lock mechanism of FIG. 4 in an unlocked state with the brake bolt attached.

FIG. 6 shows the lock mechanism of FIG. 4 in a locked state.

FIG. 7 shows a second lock mechanism of the present invention in an unlocked state with the brake bolt removed.

FIG. 8 shows the lock mechanism of FIG. 7 in an unlocked state with the brake bolt attached.

FIG. 9 shows the lock mechanism of FIG. 7 in a locked state.

FIG. 10 shows the lock mechanism of FIG. 7 after the key is turned to retract the lock bolt.

FIG. 11 shows an exploded view of the lock mechanism of FIG. 7.

FIG. 12 shows a front view of a lock of the present invention having the lock mechanism of FIG. 7.

FIG. 13 shows a third lock mechanism of the present invention in an unlocked state.

FIG. 14 shows the lock mechanism of FIG. 13 in a locked state.

### DETAILED DESCRIPTION OF THE INVENTION

The vehicle lock of the present invention is preferably used on a wheeled vehicle, including, but not limited to, a motorcycle, a moped, an all-terrain vehicle (ATV), or a snowmobile, to immobilize at least one wheel or track. The vehicle lock may be used on any vehicle without a full enclosure of the operating controls, including locking doors or hatches, such that the vehicle could be moved manually. This includes any recreational-type vehicle with an open air rider position. The vehicle lock of the present invention prevents the vehicle from being wheeled anywhere when it is engaged.

When the vehicle lock of the present invention is used for a motorcycle, it is preferably designed to be integrated into the motorcycle's brake caliper mounting bracket or the brake caliper itself. A factory brake caliper bracket is subject to high amounts of lateral load at any given time during operation of the motorcycle. Lateral load on the axis of the bracket is transferred down the axis to the caliper bracket-to-frame mounting point. This is where the axle passes through the bracket perpendicular to the bracket's axis at the vertex, transforming the lateral load into torsion. This torsion is absorbed by the axle and rear frame of the motorcycle.

When the rear brake is applied to a motorcycle, the brake pads in the brake caliper press against the lateral surfaces of the rotating brake rotor. Friction is created and the kinetic energy from the momentum of the motorcycle is transferred from the brake rotor to the brake caliper via the pads. The kinetic energy is transferred to the brake caliper via the lateral force. If the caliper is situated above the axle, the brake caliper is forced toward the front of the motorcycle. The caliper bracket holds the caliper in place. The lateral force previously transferred to the caliper is now transferred on the same plane to the caliper bracket, so it remains a lateral load. The lateral load travels down the axis of the caliper bracket to the vertex (where the axle passes through the bracket), and the energy is then transferred to the axle and rear frame via torsion (twisting force). The integrity of the brake caliper bracket is maintained, because it is designed to withstand high lateral forces created from a motorcycle in motion.

Motorcycle manufacturers determine exactly how much lateral and torsion load each bracket must withstand. The caliper bracket is subject to extremely high loads, yet it is inexpensive in design and manufacture. The vehicle lock of the present invention preferably does not alter the fundamental design of the manufacturer's brake caliper bracket. Instead, the vehicle lock of the present invention is preferably an addition to the bracket, much like the brake caliper itself.

The brake caliper bracket of a motorcycle, or even an automobile for that matter, is the strongest part of that vehicle. The lateral load exerted on the brake caliper bracket of a motorcycle traveling at 180 miles per hour (MPH) when the rider vigorously applies the brake is many times greater than the load exerted on a rotor lock by a human trying to roll a parked motorcycle forward.

In a preferred embodiment of the present invention, the lock bracket replaces the manufacturer's bracket. A deadbolt shaft, preferably made of hardened steel, stainless steel, titanium, tungsten, or boron, extends from the bracket to the brake rotor in a locked state to prevent any movement of the locked wheel with respect to the bracket, thereby making the vehicle undrivable. The strength of the bracket and the deadbolt shaft preserve the integrity of the lock and prevent or deter theft of the vehicle. The wrap-around design of the present invention encases the brake caliper in the same manner that the neighboring brake caliper does.

The lateral load exerted on the lock in the event of an attempted theft is shouldered by the deadbolt shaft, which passes through the cross-drilled ventilation hole of the brake rotor perpendicular to its axis. The deadbolt shaft is seated in the lock on either side by a bushing, which is preferably made of hardened steel. The “lateral load” state is preserved by the wrap-around design, and is transferred to the axle and frame in the same manner as the lateral loads captured by the brake caliper. If a single-sided lock were used, the lateral load would be converted into torsion at the deadbolt-to-rotor contact and the integrity of the brake caliper bracket would be compromised.

In a preferred embodiment, the lock is a motorcycle lock. The wrap-around design of the lock preserves the integrity of the locking mechanism even in the case of an extreme destruction event, such as if the bracket is cut by a cutting tool, such as a Dremel® tool, and removed from the rotor. In the event of bracket destruction, the wheel may no longer be completely immobilized, but the lock mechanism remains attached to the rotor. The wheel is not able to rotate fully, as the lock mechanism comes into contact with the brake caliper or the motorcycle frame within one revolution, thus keeping the motorcycle immobilized.

A lock of the present invention is an adaptation of the factory rear brake caliper bracket. The lock's construction preferably retains the factory measurements in regards to caliper mounting-point locations, frame mounting-point locations, and aesthetic finish. The bracket preferably meets or exceeds all standards of the original equipment manufacturer (OEM). However, the materials used for the construction yield a brake caliper bracket that withstands much higher lateral and torsion loads. The lock adds minimal weight to the rear of the motorcycle and does not hinder performance in any way.

Each vehicle lock of the present invention is preferably customized to a specific vehicle model. The lock body of the vehicle lock is preferably permanently mounted to the vehicle. When the vehicle lock is engaged, the user carries no more than a key to engage/disengage the lock. When the vehicle lock is disengaged, the user carries no more than the key and the brake bolt/deadbolt assembly, which is preferably of similar size and weight as the key.

Referring to FIG. 1, in a rear brake embodiment, a vehicle lock of the present invention is a self-contained unit housed within the caliper mounting bracket (10). The caliper mounting bracket (10) is preferably of original equipment specifications to the applicable model of vehicle. The lock is preferably used on any vehicle using a disc braking system. Some vehicles upon which the lock of the present invention may be used include, but are not limited to, motorcycles, mopeds, ATVs, and snowmobiles. The locking mechanism (12) is securely mounted in the caliper mounting bracket (10). The locking mechanism (12) includes a locking cylinder (not shown) and an externally applied deadbolt shaft (14) with a locking notch (15) closer to one end to be locked into place. The deadbolt shaft (14), when locked, enters the rotor (16) through one of the plurality of cross-drilled ventilation holes (18).

The caliper mounting bracket (10) is preferably made of cast or milled aluminum or steel meeting or exceeding OEM-specified strength. The locking mechanism (12) is preferably made of strengthened steel housing the internal components creating a locking body able to secure the deadbolt shaft (14) into place through one of the cross-drilled ventilation holes (18).

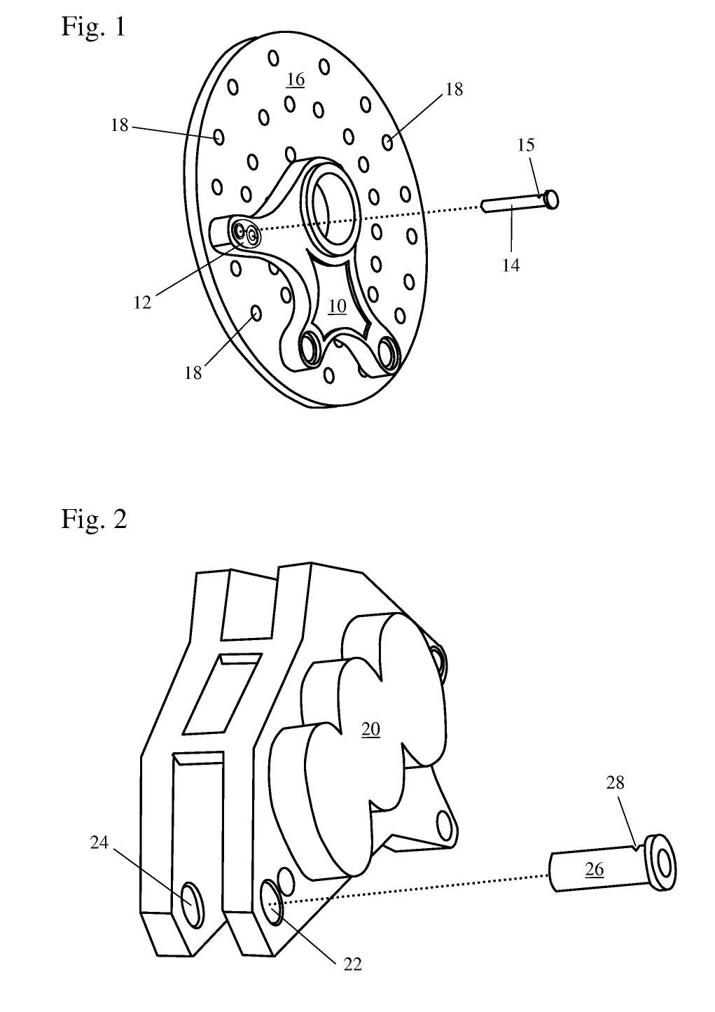

Referring to FIG. 2, in a front brake embodiment, a vehicle lock of the present invention is a self-contained unit housed within the caliper (20). The caliper (20) is preferably of original equipment specifications to each applicable model of vehicle. The lock is preferably used on any vehicle using a disc braking system. Some vehicles upon which the lock of the present invention may be used include, but are not limited to, motorcycles, mopeds, ATVs, and snowmobiles. The locking mechanism (22) is securely mounted in the caliper (20). Additionally, the caliper (20) employs a deadbolt receiver (24) on the opposite side of the locking mechanism (22) to ensure placement of the deadbolt shaft (26). In one embodiment, the deadbolt shaft is made of steel, strengthened steel, or stainless steel. However, the deadbolt shaft may be made of any metal or alloy of equal or greater tensile strength than steel, including, but not limited to, titanium, tungsten, or boron. The locking mechanism (22) includes a locking cylinder and an externally applied deadbolt shaft (26) with a locking notch (28) closer to one end to be locked into place. The deadbolt shaft (26), when locked, enters the rotor (not shown) through one of the plurality of cross-drilled ventilation holes (not shown). The caliper (20) is preferably made of cast or milled aluminum meeting or exceeding OEM-specified strength. The locking mechanism (22) is preferably made of strengthened steel housing the internal components creating a locking body able to secure the deadbolt shaft (26) into place.

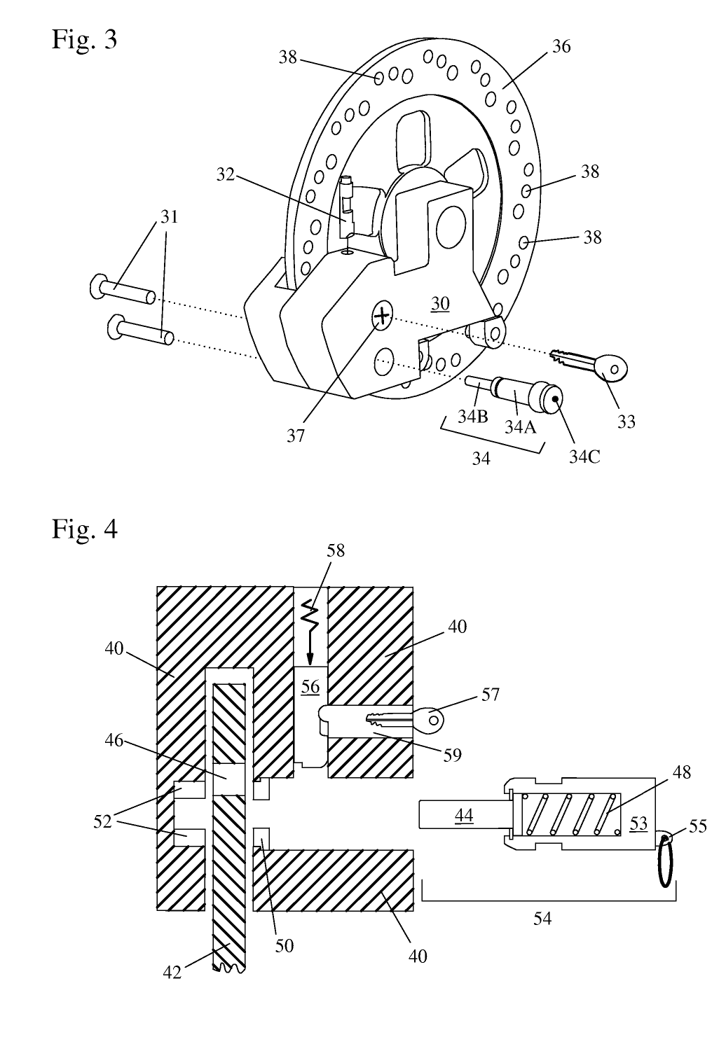

Referring to FIG. 3, a bracket (30) of the present invention is mounted to the brake rotor (36) by at least one mounting screw (31). The locking pin (32) holds the brake bolt (34) in place in the bracket (30). In a locked state, the deadbolt shaft (34B) extends from the brake bolt body (34A) and into a ventilation hole (38) of the brake rotor (36) to prevent rotation of the rotor (36) and hence the wheel or track, thereby locking the vehicle. One or more light emitting diodes (LED's) (34C) may be mounted on the brake bolt body (34A) or the bracket (30) to indicate to the user whether or not the lock is engaged for added safety and security. In this embodiment, a key (33), which is preferably a four-way key, is inserted into a keyhole of the key cylinder (37) and turned to engage and disengage the lock. In one embodiment of the engagement mechanism, the key (33) unlocks the brake bolt (34) by releasing the locking pin (32) from the locked position. The key cylinder (37) is mounted in the body of the bracket (30) itself. In this embodiment, the only part that has a positive engaging lock is the brake bolt body (34A).

Several different mechanisms may be used with the present invention to engage and disengage the vehicle lock. In a first embodiment, shown in FIG. 4 through FIG. 6, a key manually unlocks the brake bolt and retraction of the spring-loaded locking pin allows the brake bolt assembly, including the deadbolt and the deadbolt spring to be removed from the bracket. Referring to FIG. 4, a lock mechanism of the present invention is preferably located in the bracket (40), which is mounted in place of the original bracket of the vehicle. The mounted bracket (40) preferably surrounds at least part of the brake rotor (42). To disengage the lock for use of the vehicle, the user inserts and turns the key (57), which is preferably a multi-combination key with four key-ways, to turn the key cylinder (59). This retracts the locking pin (56) and allows the user to remove the brake bolt (54), which includes the deadbolt (44), the deadbolt spring (48), and the brake bolt body (53), from the bracket (40). The assembly preferably includes a pull ring (55) attached to the brake bolt body (53) to allow the user to remove the assembly (54) from the bracket (40). When the lock is unlocked, the brake bolt (54), which is preferably compact and lightweight, can be easily stored by the owner, for example in the owner's pocket. In a preferred embodiment, the pull ring (55) is a keychain loop, so that the brake bolt (54) may be easily stored, for example by fastening the brake bolt to the owner's belt or another keychain.

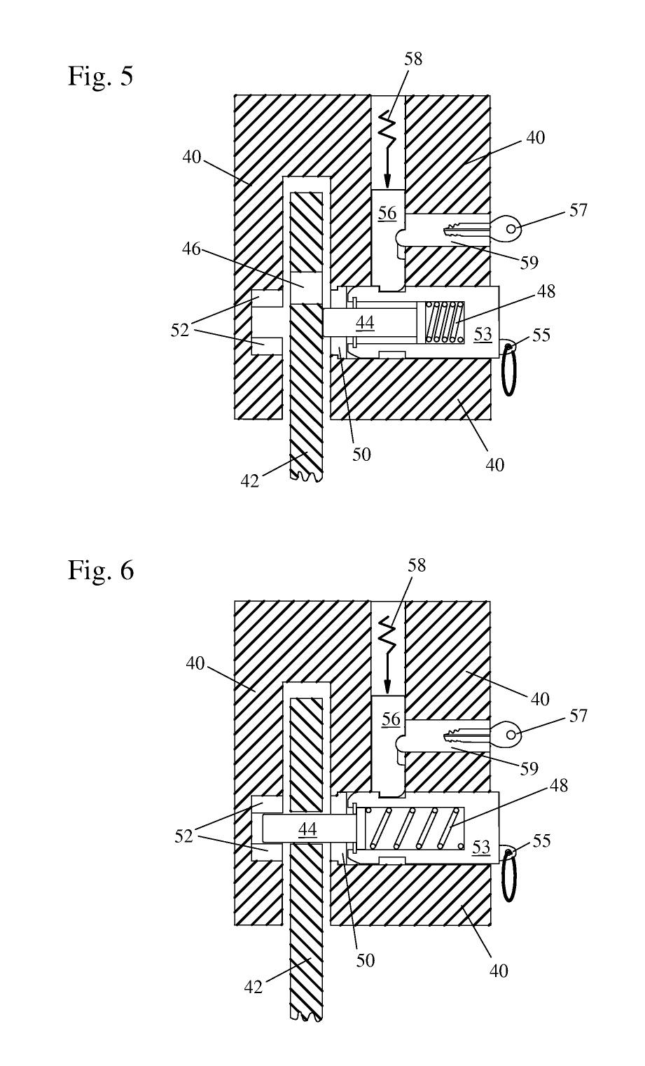

Referring to FIG. 5, to engage the lock, the user first inserts the brake bolt (54) into the bracket (40) and turns the key (57) to the lock position. This turns the key cylinder (59) to allow the locking pin spring (58) to urge the locking pin (56) toward the brake bolt (54) and engage the brake bolt body (53) so that it holds the brake bolt (54) in place.

Referring to FIG. 6, to complete the engagement of the lock, since the brake rotor (42) rotates with respect to the bracket (40) when unlocked, to lock the vehicle the user rolls the vehicle forward or backward until one of the ventilation holes (42) lines up with the deadbolt shaft (44). When the shaft (44) is aligned with a hole (42), the deadbolt spring (48) urges the shaft (44) through the hole (42) to engage the lock and prevent further movement of the brake rotor (42). The deadbolt (44) preferably extends into bushings (50, 52), which are preferably made of hardened steel, on either side of the brake rotor (42) to increase the strength of the lock. The deadbolt spring (48) is mounted in the brake bolt (54). The brake bolt (54) is held in position by the locking pin (56) that is urged toward the brake bolt (54) by the locking pin spring (58).

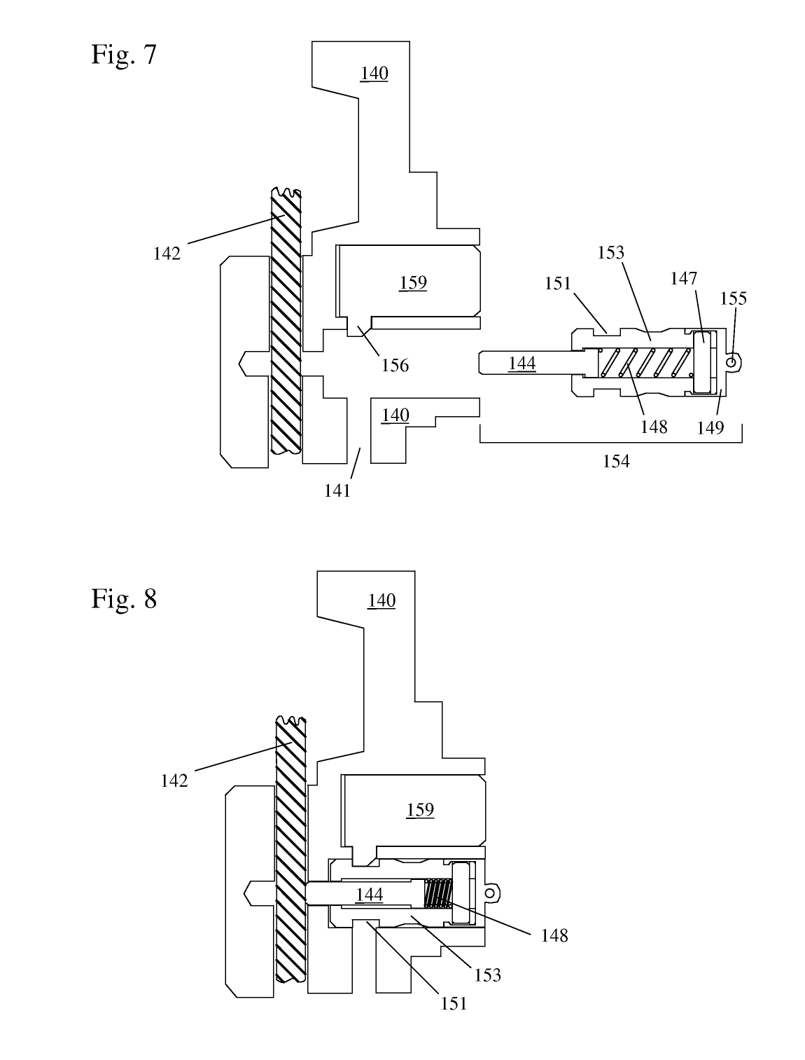

Referring to FIG. 7 through FIG. 10, in a second embodiment of a locking mechanism with a removable brake bolt (154), a diameter groove (151) in the brake bolt body (153) and a security pin (147) under the brake bolt cap (149) increase the security of the engaged locking mechanism by inhibiting a drilling attack to the brake bolt (154). The security pin (147) is preferably made of hardened steel and inhibits drilling farther into the brake bolt body (153) or into the deadbolt (144). The diameter groove (151) preferably goes completely around the brake bolt body (153) so that drilling tends only to spin the brake bolt (154) when it is locked in position in the bracket (140) by the locking pin (156). The bracket (140) further includes a drain passage (141).

The locking mechanism preferably allows for one-handed locking and unlocking of the vehicle lock. As shown in an unlocked state in FIG. 7, the locking pin (156) is preferably spring-loaded to extend from the lock cylinder (159) into the brake bolt bore when no key is in the lock cylinder (159). One-handed insertion of the brake bolt (154) into the brake bolt bore, as shown in FIG. 8, causes retraction of the deadbolt (144) into the brake bolt body (153) and subsequent compression of the pressure spring (148), assuming that the deadbolt (144) does not happen to line up with a ventilation hole in the rotor (142), until the diameter groove (151) lines up with the locking pin (156). At this point, as shown in FIG. 8, the vehicle is locked even though the deadbolt (144) does not extend through a ventilation hole in the rotor (142).

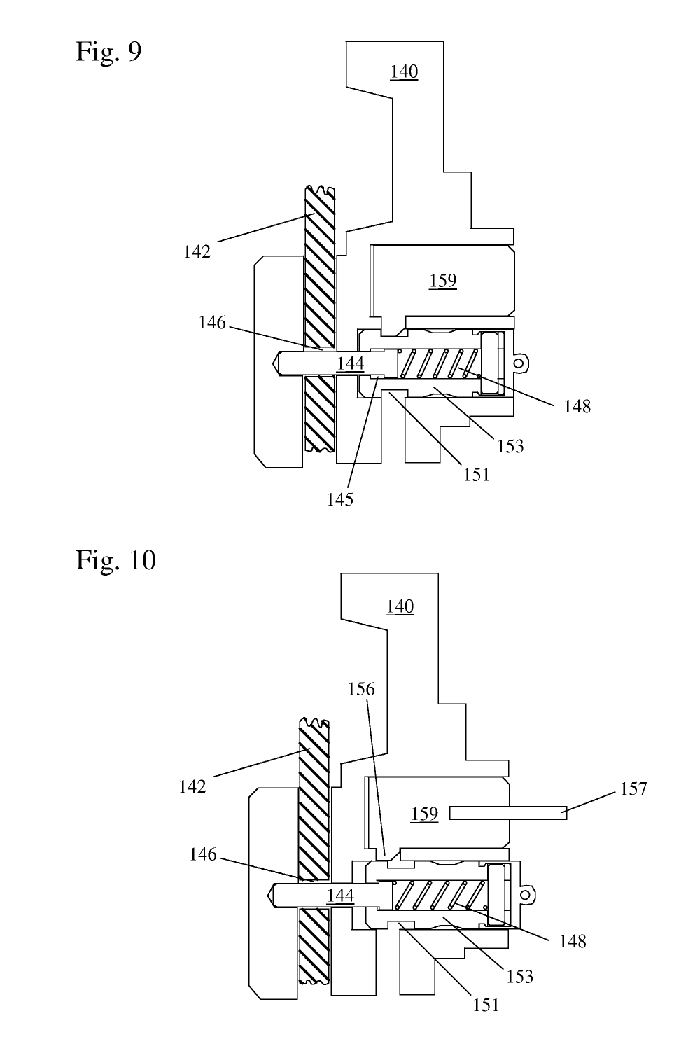

As shown in FIG. 9, the vehicle user may move the vehicle until a ventilation hole (146) lines up with the deadbolt (144) to achieve a positive lock, but if the user forgets this step, any potential thief who tries to roll the vehicle away would engage the lock, locking the wheel and preventing further rolling of the vehicle. The pressure spring (148) provides for this feature. As also shown in FIG. 9, the brake bolt (154) is preferably designed so that in the positive lock state, a pressure gap (145) remains between the head of the deadbolt (144) and the end of the brake bolt body (153). This feature allows for one-handed unlocking of the vehicle by use of a key (157) in the lock cylinder (159), which retracts the locking pin (156). When the locking pin (156) retracts, the pressure gap (145) allows the pressure spring (148) to extend farther until the head of the deadbolt (144) contacts the end of the brake bolt body (153), as shown in FIG. 10. Since the deadbolt (144) can not extend farther into the bracket (140), the brake bolt body (153) instead moves outward from the brake bolt bore so that after the key (157) is released, the user manually pulls the unlocked brake bolt (154) out of the bracket (140) prior to use of the vehicle.

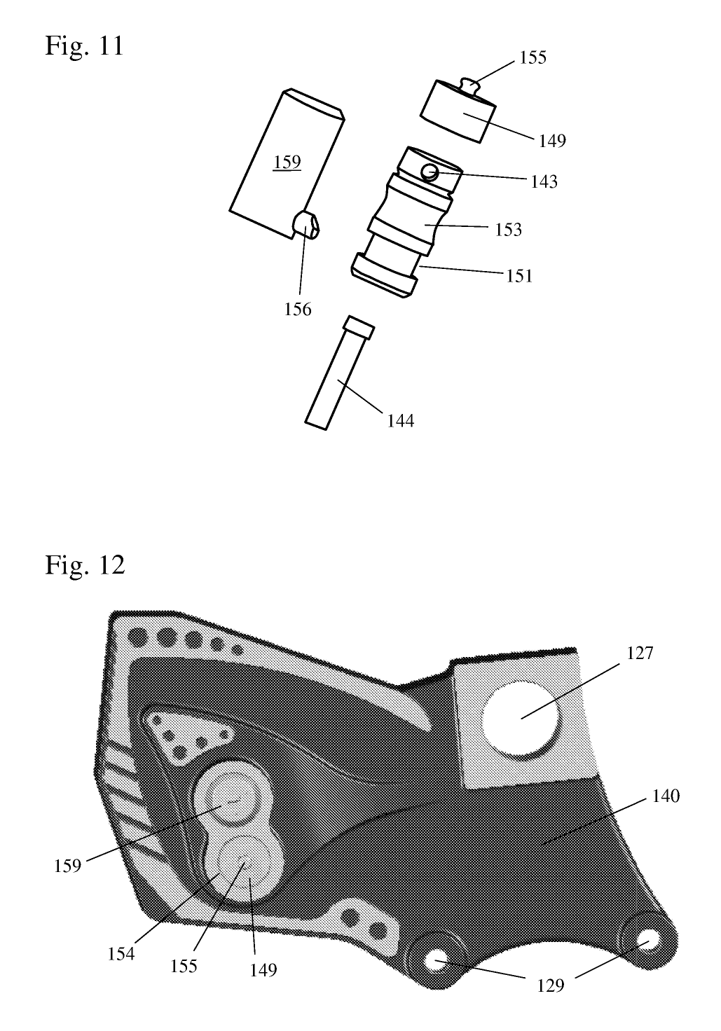

In the exploded view of the brake bolt (154) and the lock cylinder (159) in FIG. 11, the security pin bore (143) is visible in the brake bolt body (153). For assembly of the brake bolt (154), the deadbolt (144) is first inserted into the deadbolt bore down the center of the brake bolt body (153) followed by the pressure spring (148). The pressure spring (148) is then held down in the deadbolt bore while the security pin (147) is inserted into the security pin bore (143). Finally, the brake bolt cap (149) is placed over the end of the brake bolt body (153), covering the security pin (147), and is swaged or crimped into place on the brake bolt body (153).

The front view of a preferred design of the vehicle lock is shown in FIG. 12. The relative locations of the lock cylinder (159), the brake bolt (154), the axle hole (127), and the caliper mounting holes (129) on the bracket (140) are shown. A custom bracket (140) is preferably designed for each make and model of vehicle.

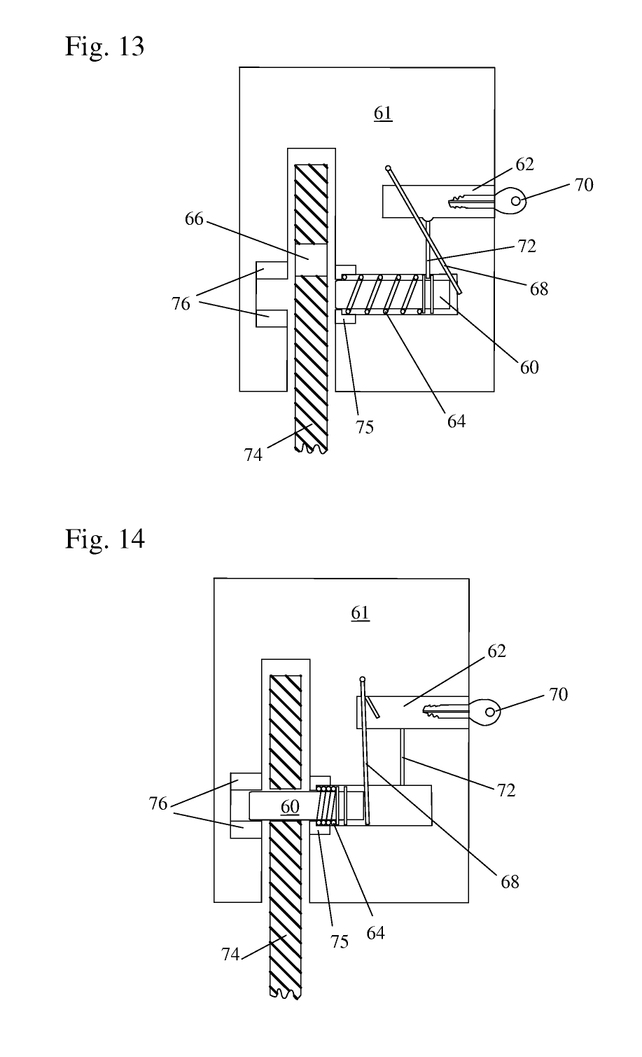

In a third engagement embodiment, the deadbolt (60) is an internal part of the mounted bracket (61). In an unlocked state as shown in FIG. 13, the lock cylinder (62) is positioned such that the deadbolt retainer spring (64) has extended to retract the deadbolt (60) from the ventilation hole (66) and to move the hinged pin engagement bar (68) to the unlock position. When the key (70) and lock cylinder (62) are completely turned to release the lock, the fail-safe lock out plate (72) secures the internal deadbolt (60) to prevent accidental engagement while the lock is not in use.

To go to the locked position of FIG. 14, the lock cylinder (62) is turned with the appropriate key (70), which retracts the fail-safe lock out plate (72) and depresses the hinged pin engagement bar (68) pressing on the internal deadbolt (60), going through the ventilation rotor hole (66) of the brake rotor (74). The key then turns in reverse to take pressure off the hinged pin engagement bar, allowing the internal pin (60) to be retracted by the internal pin retainer spring (64). As in the previous embodiment, the deadbolt (60) preferably extends into bushings (75, 76), which are preferably made of hardened steel, on either side of the brake rotor (74) to increase the strength of the lock.

The deadbolt (60) remains mounted in the bracket (61) in both a locked and an unlocked state. The key (70) is the only removable part, allowing for even more convenience when it comes to lock storage. Although a specific pin extraction mechanism and fail-safe lock out mechanism are shown in this embodiment, other extraction and lock out mechanisms may be used within the spirit of the present invention. In an alternate embodiment, the lock cylinder may be directly attached to the deadbolt shaft to apply the pressure needed to push the shaft through the ventilation hole, allowing the rotor to be locked. In an alternate embodiment, a plate covers the brake bolt hole in the lock bracket to secure the brake bolt inside the housing to eliminate accidental engagement.

In a fourth engagement embodiment, the lock is engaged and disengaged electronically. When the user turns on the ignition, the lock disengages, and when the user turns off the ignition, the lock engages. The lock is preferably wired in with the electronics on the vehicle. When the ignition is turned on, the solenoid acts as the lock cylinder, facilitating all the internal movements of the deadbolt and the metal plate blocking the accidental engagement. The installation may be done by the owner and purchaser. If the lock is wired in with the vehicle's electronics, then dealer installation is preferable. The electronic control may additionally use radio frequency identification (RFID) technology with an external power source for an increased level of security and correct owner identification. The RFID also eliminates the need to use the motorcycle's power supply for correct lock function. If the lock uses RFID technology, the installation is similar to installation of the mechanical key embodiments. No wiring is necessary because the power source is external. In this embodiment, the entire vehicle lock is permanently mounted to the vehicle, and the user does not even need to carry a key for the vehicle lock.

For any of these embodiments, one or more light-emitting diodes (LED's) may be housed in the brake bolt or the bracket to indicate to the user whether or not the lock is engaged for added safety and security.

Although all of the described embodiments include only a single deadbolt engaging the rotor, multiple deadbolts may be used to engage multiple ventilation holes in the rotor simultaneously for increased security within the spirit of the present invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A vehicle lock for a vehicle having at least one wheel or track having a brake rotor with a plurality of ventilation holes or slots, the vehicle lock comprising:
a lock body permanently mounted to the vehicle;
a lock cylinder mounted in a lock bore of the lock body;
a locking pin extending from the lock cylinder; and
a brake bolt selectively mountable in a brake bolt bore in the lock body and comprising:
a brake bolt body having a deadbolt bore and a diameter groove located around the full circumference of the brake bolt body; and
a deadbolt extending from the deadbolt bore;
such that in a locked state the locking pin inserts into the diameter groove to hold the brake bolt in the lock body while the diameter groove allows 360° of rotation of the brake bolt body in the brake bolt bore.

2. The vehicle lock of claim 1, wherein the lock body is mounted to an axle of the wheel.

3. The vehicle lock of claim 1, wherein the lock body flanks both sides of at least a part of the brake rotor such that in the locked state the deadbolt shaft extends from the brake bolt body through the at least one ventilation hole or slot and into a recess in the brake body.

4. The vehicle lock of claim 3, wherein the deadbolt shaft extends through a first bushing at the end of the brake bolt and in the locked state the deadbolt shaft extends into a second bushing in the recess.

5. The vehicle lock of claim 3, the brake bolt further comprising a pressure spring biasing the deadbolt outward from the brake bolt body, wherein in the locked state the deadbolt contacts a back surface of the recess prior to a head of the deadbolt contacting an end surface of the deadbolt bore such that when the locking pin is retracted from the brake bolt bore, the pressure spring pushes the brake bolt body outward from the brake bolt bore until the head of the deadbolt contacts the end surface of the deadbolt bore and the locking pin no longer engages the diameter groove when unretracted.

6. The vehicle lock of claim 1, the brake bolt further comprising a security pin located in a security pin bore in the brake bolt body and substantially perpendicular to the deadbolt bore such that the security pin inhibits penetration of a drilling attack to the brake bolt in the locked state.

7. The vehicle lock of claim 1, the brake bolt further comprising a pressure spring biasing the deadbolt outward from the brake bolt body.

8. A vehicle lock for a vehicle having at least one wheel or track having a brake rotor with a plurality of ventilation holes or slots, the vehicle lock comprising:
a lock body permanently mounted to the vehicle;
a lock cylinder mounted in a lock bore of the lock body;
a locking pin extending from the lock cylinder; and
a brake bolt selectively mountable in a brake bolt bore in the lock body and comprising:
a brake bolt body having a deadbolt bore, a security pin bore substantially perpendicular to the deadbolt bore, and a diameter groove located in the exterior of the brake bolt body such that in a locked state the locking pin inserts into the diameter groove to hold the brake bolt in the lock body;
a deadbolt extending from the deadbolt bore; and
a security pin located in the security pin bore;
such that the security pin inhibits penetration of a drilling attack to the brake bolt.

9. The vehicle lock of claim 8, wherein the lock body is mounted to an axle of the wheel.

10. The vehicle lock of claim 8, wherein the lock body flanks both sides of at least a part of the brake rotor such that in the locked state the deadbolt shaft extends from the brake bolt body through the at least one ventilation hole or slot and into a recess in the brake body.

11. The vehicle lock of claim 8, the brake bolt further comprising a pressure spring biasing the deadbolt outward from the brake bolt body.

12. A vehicle lock for a vehicle having at least one wheel or track having a brake rotor with a plurality of ventilation holes or slots, the vehicle lock comprising:
a lock body permanently mounted to the vehicle;
a lock cylinder mounted in a lock bore of the lock body;
a locking pin extending from the lock cylinder; and
a brake bolt selectively mountable in a brake bolt bore in the lock body and comprising:
a brake bolt body having a deadbolt bore and a diameter groove located in the exterior of the brake bolt body such that in a locked state the locking pin inserts into the diameter groove to hold the brake bolt in the lock body;
a deadbolt extending from the deadbolt bore; and
a pressure spring biasing the deadbolt outward from the brake bolt body.

13. The vehicle lock of claim 12, wherein the lock body is mounted to an axle of the wheel.

14. The vehicle lock of claim 12, wherein the lock body flanks both sides of at least a part of the brake rotor such that in a locked state the deadbolt shaft extends from the brake bolt body through the at least one ventilation hole or slot and into a recess in the brake body.

15. A method of locking a vehicle having at least one wheel or track having a brake rotor with a plurality of ventilation holes or slots, the method comprising the step of:
inserting a brake bolt into a brake bolt bore of a lock body permanently mounted to the vehicle until a locking pin inserts into a diameter groove of the brake bolt to hold the brake bolt in the lock body;
wherein the brake bolt comprises:
a brake bolt body having a deadbolt bore;
a diameter groove located in the exterior of the brake bolt body; and
a deadbolt extending from the deadbolt bore; and
wherein the lock body further comprises:
a lock cylinder mounted in a lock bore of the lock body; and
the locking pin biased to extend from the lock cylinder into the brake bolt bore.

16. The method of claim 15, wherein the lock body is mounted to an axle of the wheel.

17. The method of claim 15, wherein the lock body flanks both sides of at least a part of the brake rotor such that in a locked state the deadbolt shaft extends from the brake bolt body through the at least one ventilation hole or slot and into a recess in the lock body.

18. The method of claim 15 further comprising the step of rolling the wheel until the deadbolt is aligned with one of the ventilation holes or slots such that the deadbolt extends into the ventilation hole or slot.

19. A method of unlocking a vehicle having at least one wheel or track having a brake rotor with a plurality of ventilation holes or slots, the method comprising the step of:
actuating a lock cylinder to retract a locking pin from a diameter groove such that a pressure spring biasing a deadbolt toward the brake rotor pushes a brake bolt body outward from a brake bolt bore in a lock body such that when the lock cylinder is no longer actuated a brake bolt may be pulled from the brake bolt bore;
wherein the lock body is permanently mounted to the vehicle and comprises a lock bore and the brake bolt bore;
wherein the brake bolt comprises:
the brake bolt body having a deadbolt bore;
the diameter groove located in the exterior of the brake bolt body;
the pressure spring; and
the deadbolt extending from the deadbolt bore; and
wherein the lock body further comprises:
the lock cylinder mounted in the lock bore; and
the locking pin biased to extend from the lock cylinder into the brake bolt bore in an unactuated state.

20. The method of claim 19, wherein the lock body is mounted to an axle of the wheel.

21. The method of claim 19, wherein the lock body flanks both sides of at least a part of the brake rotor such that in a locked state the deadbolt shaft extends from the brake bolt body through the at least one ventilation hole or slot and into a recess in the lock body.

22. The method of claim 19, wherein the step of actuating the lock cylinder comprises the substeps of inserting a key into the lock cylinder and turning the key in the lock cylinder.
